(19) United States
(12) Patent Application Publication
(10) Pub. No.: US 2024/0239418 A1
(43) Pub. Date: Jul. 18, 2024

(54) Molded Rubber Inner Frame for Vehicles and Airplanes

(71) Applicant: Chukwudi C. Amajioyi, Vacaville, CA (US)

(72) Inventor: Chukwudi C. Amajioyi, Vacaville, CA (US)

(21) Appl. No.: 18/329,177

(22) Filed: Jun. 5, 2023

Related U.S. Application Data
(60) Provisional application No. 63/438,595, filed on Jan. 12, 2023.

(51) Int. Cl. B62D 29/04; B62D 21/15

(52) U.S. Cl. CPC B62D 29/043; B62D 21/15

(57) ABSTRACT

A redesigned vehicle and aircraft interior structure made of molded rubber, which replaces traditional metal structures. The molded rubber structure is made using a rubber molding process and provides stability to the vehicle or aircraft and reduces damage in the event of a collision. The structure includes various cavities for accommodating different vehicle components such as the engine, windshield screen, trunks, and more. The metal body of the vehicle or aircraft is attached to the rubber structure using adhesive or fasteners for aesthetic purposes. The new design of the present invention can make repairs more manageable and less costly since the rubber structure is easier to manipulate than metal.

### CROSS-REFERENCE TO RELATED APPLICATION

The present application claims priority to, and the benefit of, U.S. Provisional Application No. 63/438,595, which was filed on Jan. 12, 2023, and is incorporated herein by reference in its entirety.

### FIELD OF THE INVENTION

The present invention generally relates to the field of structures of vehicles and aircraft. More specifically, the present invention relates to a novel inner or interior structure for cars, trucks, SUVs, aircraft, and more. The structure utilizes a molded rubber material instead of metal thus reducing manufacturing costs and damage during a collision. A metal body is installed on the structure for providing a structure similar to a conventional vehicle. Accordingly, the present disclosure makes specific reference thereto. Nonetheless, it is to be appreciated that aspects of the present invention are also equally applicable to other like applications, devices, and methods of manufacture.

### BACKGROUND

By way of background, standard vehicles and airplanes are typically constructed using metal, which is a durable and sturdy material that can withstand high impact forces. Metal used in vehicles is not inherently unsafe, however, the use of metal in vehicles can present some safety concerns in certain situations. For instance, metal can deform and crumple under high impact forces, potentially causing injury to passengers. Further, metal is also relatively expensive compared to other materials, which contributes to the high manufacturing costs of vehicles and airplanes.

Event of a collision or impact resulting from high velocity in conventional vehicles and airplanes often leads to fatalities, implying that the safety measures in place in standard vehicles and airplanes are not enough to prevent fatalities. Furthermore, certain damages resulting from a collision may be unrepairable, leading to significant financial losses for insurance companies. For instance, if a vehicle or airplane is beyond repair, the insurance company may need to pay out the full cost of the vehicle or airplane to the policyholder, resulting in a significant financial loss. Even for repairable events, the cost of repairing the damage is high, which may result in significant expenses for the policyholder or the owner of the vehicle or airplane.

Lastly, the cost to manufacture cars and airplanes remains high due to the amount of metal used in their construction. Vehicles and airplanes are built with metal frames. Individuals desire a new structural design for standard vehicles and airplanes that make repairs more manageable, less costly and improves safety of passengers.

Therefore, there exists a long felt need in the art for a modified inner or interior structure for cars, trucks, SUVs, aircraft, and more. There is also a long felt need in the art for a vehicular inner or interior structure that reduces manufacturing costs for any type of vehicle such as cars, airplanes, and more. Additionally, there is a long felt need in the art for a modified vehicular inner or interior structure that improves safety of passengers. Moreover, there is a long felt need in the art for an improved inner or interior structure for vehicles and airplanes that reduces damage done to a vehicle in the event of a collision. Further, there is a long felt need in the art of a modified vehicular inner or interior structure that utilizes a molded rubber material instead of metal to create the interior structure. Furthermore, there is a long felt need in the art for an improved inner or interior structure for vehicles and aircrafts that make repairs more manageable and less costly. Finally, there is a long felt need in the art for a redesigned vehicle and airplane structure that improves safety, reduces manufacturing costs, and makes repairs more manageable and less expensive.

The subject matter disclosed and claimed herein, in one embodiment thereof, comprises a redesigned vehicle interior frame made of molded rubber. The frame is designed to reduce manufacturing costs for any type of vehicle such as cars, airplanes, and more and can be designed for any type of vehicle and aircraft. The frame further includes a modified inner or interior structure made of molded rubber material for reducing damage to the vehicle in the event of a collision, and the structure comprising a screen cavity formed by a plurality of screen pillars, a roof panel, a rear quarter panel for accommodating trunks/boots, a front panel forming a cavity for accommodating an engine and other electronic components, a scuttle member for supporting the front panel, a base member designed to support a base of the vehicle, and center pillars for providing support to the doors and sides of the vehicle.

In this manner, the redesigned vehicle interior frame of molded rubber of the present invention for cars, trucks, SUVs, aircraft, and more accomplishes all of the forgoing objectives and provides users with a modified inner or interior structure for cars, trucks, SUVs, aircrafts, and more. The inner or interior structure is cost-effective, helps to absorb and distribute impact forces better than metal and prevents excess damage in the event of an accident. The flexibility of the rubber structure can also help to reduce the noise and vibration of the vehicle or airplane.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a redesigned vehicle interior frame made of molded rubber. The frame further comprising a modified inner or interior structure made of molded rubber material, wherein the molded rubber provides a stable shape to the vehicle and reduces damage to the vehicle in the event of a collision, and the structure comprising a screen cavity formed by a plurality of screen pillars, a roof panel, a rear quarter panel for accommodating trunks/boots, a front panel forming a cavity for accommodating engine and other electronic components, a scuttle member for supporting the front panel, a base member designed to support base of the vehicle, and center pillars for providing support to the doors and sides of the vehicle. The redesigned vehicle interior frame is constructed using injection molding or liquid silicone rubber (LSR) molding.

In a further embodiment, the molded rubber is one or more of synthetic rubber, EPDM Rubber, Nitrile Rubber, and Silicone Rubber.

In yet another embodiment, a vehicle with a molded rubber inner frame is disclosed. The vehicle includes a molded rubber structure frame for providing a stable shape to the vehicle and a conventional automotive metal body attached to the frame for aesthetic purposes, wherein the metal body includes conventional vehicle structural components such as doors, roof, front portion, and more. The metal body is fastened to the molded rubber frame using mechanical fasteners or adhesives.

In a further embodiment, a method for manufacturing a vehicle or aircraft with a molded rubber interior frame is described. The method comprising the steps of selecting a molded rubber material, designing the rubber frame using computer-aided design (CAD) software considering the desired shape, size, and functionality of the vehicle or aircraft, manufacturing the rubber frame using one of the molding processes, which can be produced in multiple sections, then joined together using adhesives or mechanical fasteners, installing a metal body onto the rubber frame by aligning and fastening the metal body; and adding interior and exterior components to the vehicle.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a redesigned vehicle interior structure of the present invention in accordance with the disclosed architecture;

FIG. 2 illustrates a perspective view of a vehicle made with the molded rubber inner or interior structure of the present invention in accordance with the disclosed architecture;

FIG. 3 illustrates a perspective view showing collision of two vehicles in which one vehicle has molded rubber inner or interior structure in accordance with the disclosed architecture;

FIG. 4 illustrates a flow chart depicting a process of making a redesigned vehicle or aircraft with the molded rubber interior structure of the present invention in accordance with the disclosed architecture; and

FIG. 5 illustrates an enlarged view of one embodiment of the molded rubber used in the molded rubber frame of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a modified inner or interior structure for cars, trucks, SUVs, aircraft, and more. There is also a long felt need in the art for a vehicular inner or interior structure that reduces manufacturing costs for any type of vehicle such as cars, airplanes, and more. Additionally, there is a long felt need in the art for a modified vehicular inner or interior structure that improves safety of passengers. Moreover, there is a long felt need in the art for an improved inner or interior structure for vehicles and airplanes that reduces resultant damage to a vehicle in the event of a collision. Further, there is a long felt need in the art of a modified vehicular inner or interior structure that utilizes a molded rubber material instead of metal to create the interior structure. Furthermore, there is a long felt need in the art for an improved inner or interior structure for vehicles and aircrafts that makes repairs more manageable and less costly. Finally, there is a long felt need in the art for a redesigned vehicle and airplane structure that improves safety, reduces manufacturing costs, and makes repairs more manageable and less expensive.

The present invention, in one exemplary embodiment, is a method for manufacturing a vehicle or aircraft with a molded rubber interior frame. The method comprising the steps of selecting a molded rubber material, designing the rubber frame using computer-aided design (CAD) software considering the desired shape, size, and functionality of the vehicle or aircraft, manufacturing the rubber frame using one of the molding processes, which can be produced in multiple sections, then joined together using adhesives or mechanical fasteners, installing a metal body onto the rubber frame by aligning and fastening the metal body, and cutting out doors and windows from the metal body.

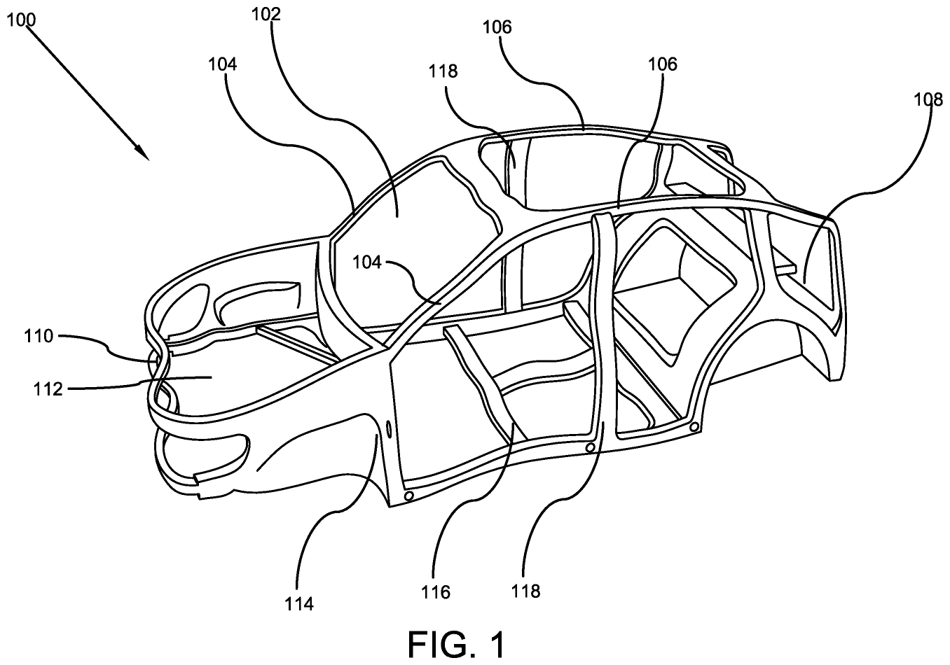

Referring initially to the drawings, FIG. 1 illustrates a perspective view of one potential embodiment of redesigned vehicle interior structure of the present invention in accordance with the disclosed architecture. The redesigned vehicle interior structure 100 of the present invention is designed as a modified inner or interior structure for cars, trucks, SUVs, aircrafts, and more and is made of molded rubber material instead of metal. The molded rubber provides a stable shape to the vehicle and reduces damage to the vehicle in the event of a collision. More specifically, the molded rubber structure 100 includes a screen cavity 102 formed by the screen pillars 104, the screen cavity 102 is used for installing a windshield screen. A roof panel 106 is formed in continuation to the screen pillar 104 and a rear quarter panel 108 is used for accommodating trunks/boots.

A front panel 110 forms a cavity 112 for accommodating an engine and other electronic components such as batteries securely. The front panel 110 has a scuttle member 114 for supporting the front panel 110. A base member 116 of the frame 100 is designed to support a base of the vehicle. The center pillars 118 are used for providing support to the doors and sides of the vehicle in conjunction with using the molded rubber vehicle interior structure 100.

The frame 100 in the preferred embodiment has a one-piece structure and can be constructed using injection molding or liquid silicone rubber (LSR) molding. It should be noted that the specific technology used for manufacturing a redesigned car and an airplane inner or interior structure 100 depends on the specific requirements of the vehicle or airplane design, such as the desired shape, volume, and complexity of the rubber interior structure. One or more synthetic rubber, EPDM Rubber, Nitrile Rubber, and Silicone Rubber can be used for making the redesigned vehicle interior structure 100.

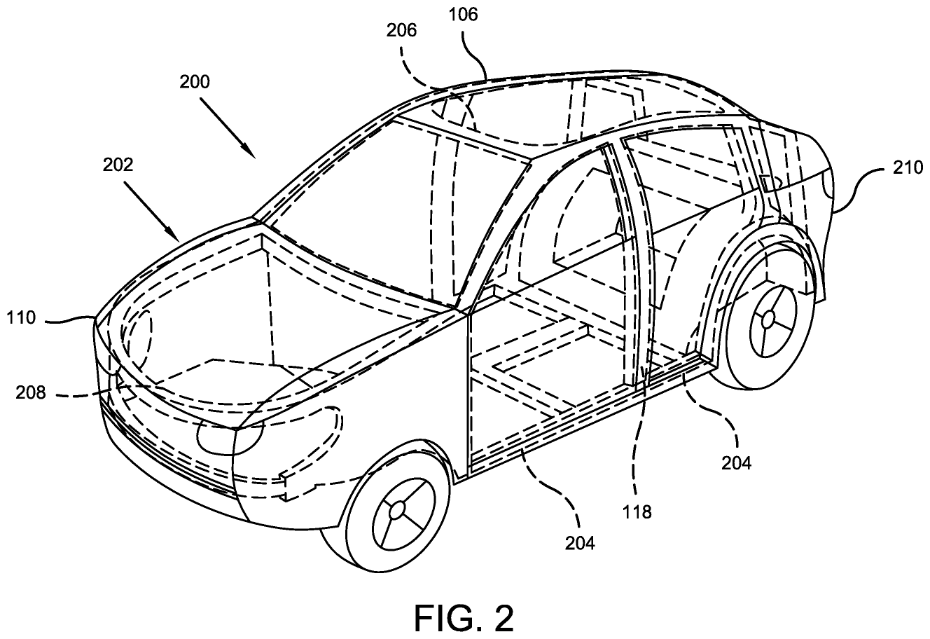

FIG. 2 illustrates a perspective view of a vehicle made with the molded rubber inner or interior structure of the present invention in accordance with the disclosed architecture. For making a vehicle 200 using the molded rubber structure 100, conventional automotive metal body 202 is attached to the structure 100 for aesthetic purposes. The metal body 202 includes conventional vehicle structural components such as doors 204, roof 206, front portion 208, and more.

The automotive metal body 202 is aligned with the molded rubber structure 100 and is fastened using mechanical fasteners (not shown). In some embodiments of the present invention, different pieces of the metal body 202 can be fastened using adhesives. In one embodiment, the metal body 202 has pre-cut openings for doors and windows and in other embodiments, the cut openings are cut out from the metal body 202 after installation of the metal body 202. As illustrated, the engine/front portion 208 is aligned with front panel 110 of the frame 100. Similarly, roof 206 is aligned with roof panel 106, doors 204 are aligned with center pillars 118, and trunk 210 of the metal body 202 aligns with rear quarter panel 108 of the frame 100.

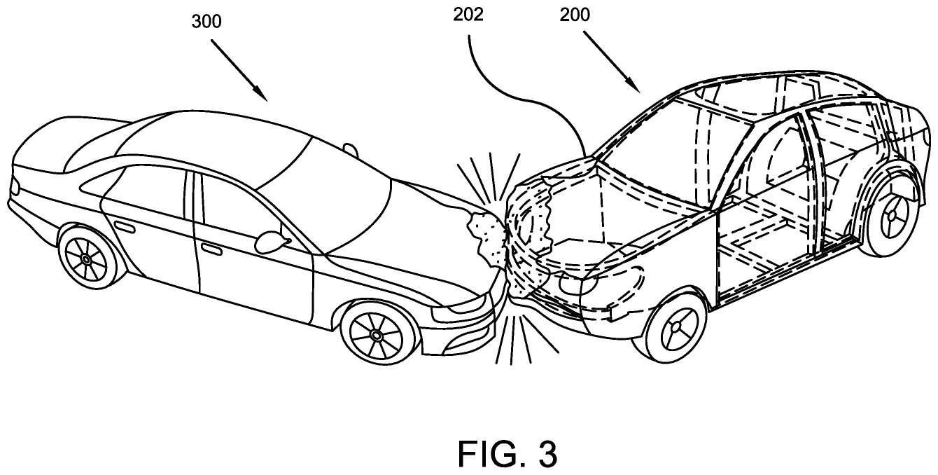

FIG. 3 illustrates a perspective view showing collision of two vehicles in which one vehicle has molded rubber inner or interior structure in accordance with the disclosed architecture. One advantage of molded rubber inner or interior structure 100 is to help prevent excess damage to the vehicle made using the structure 100 in the event of an accident or collision. The rubber structure 100 is designed to absorb and distribute impact forces better than metal, reducing the likelihood of severe injuries or death in an accident. As illustrated, the vehicle 200 having internal molded rubber structure 100 and another vehicle 300 collides head-on causing the damage caused only to external metal body 202 of the vehicle 200. The rubber structure 100 does not get damaged and thereby protects passengers sitting inside the vehicle 200. Also, the rubber structure 100 absorbs more of the impact, preventing excess damage to the metal exterior. The molded rubber structure 100 also reduces damage and makes repairs more manageable and less costly since the rubber structure is easier to manipulate and reshape when compared with steel/metal.

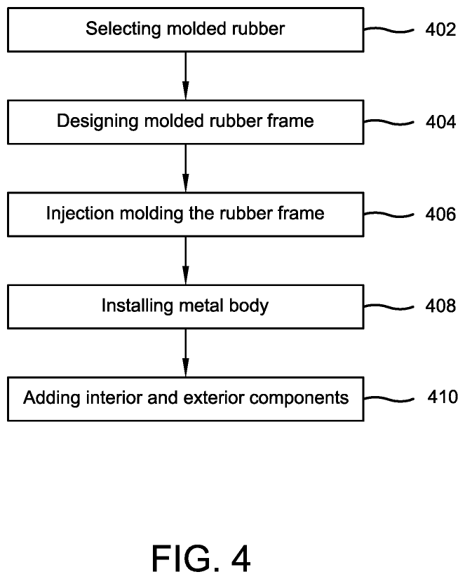

FIG. 4 illustrates a flow chart depicting a process of making a redesigned vehicle or aircraft with the molded rubber interior of the present invention in accordance with the disclosed architecture. Initially, based on design and specification of a vehicle of aircraft, molded rubber is selected (Step 402). The selection can be based on different parameters including durometer, tensile strength, elongation at failure, and more. Then, the rubber frame for the vehicle or aircraft, considering the desired shape, size, and functionality is designed using software such as computer-aided design (CAD) software (Step 404). Then, the rubber frame is manufactured using one of the molding processes and can be produced in multiple sections, which are then joined together using adhesives or mechanical fasteners (Step 406).

Thereafter, the metal body of the vehicle is installed onto the frame by aligning and fastening the metal body (Step 408). Finally, the interior and exterior components of the vehicle such as seats, dashboard, electronics, lights, and mirrors are added to the vehicle (Step 410).

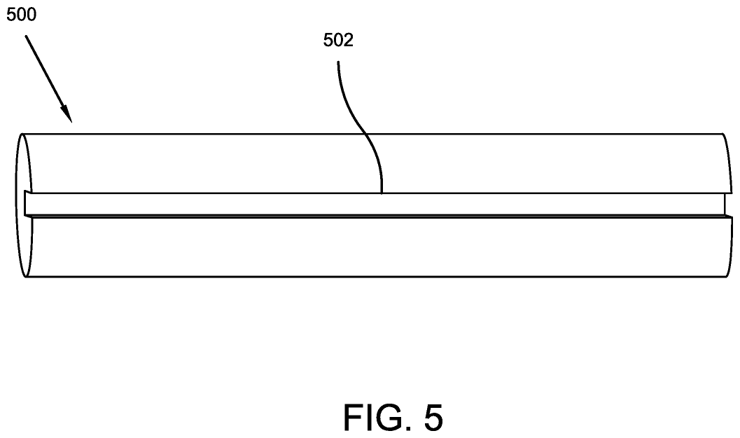

FIG. 5 illustrates an enlarged view of one embodiment of the molded rubber used in the molded rubber frame of the present invention in accordance with the disclosed architecture. In the present embodiment, the molded rubber 500 has a recess or channel 502 along the length thereof for carrying electric circuit or any other electronic connection therethrough. The channel 502 allows the molded rubber frame 100 to be used for making electronic and electronic control unit (ECU) connection of the vehicle. The molded rubber 500 is resistant to a wide range of chemicals, such as oils, fuels, and solvents and can withstand a wide range of temperatures, from extreme heat to extreme cold.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “molded rubber frame”, “redesigned vehicle interior structure”, “molded rubber structure”, “molded rubber inner or interior structure”, and “frame” are interchangeable and refer to the redesigned vehicle interior molded rubber structure 100 of the present invention.

Notwithstanding the forgoing, the redesigned vehicle interior molded rubber structure 100 of the present invention can be of any suitable size and configuration as is known in the art without affecting the overall concept of the invention, provided that it accomplishes the above stated objectives. One of ordinary skill in the art will appreciate that the redesigned vehicle interior molded rubber structure 100 as shown in the FIGS. are for illustrative purposes only, and that many other sizes and shapes of the redesigned vehicle interior molded rubber structure 100 are well within the scope of the present disclosure. Although the dimensions of the redesigned vehicle interior molded rubber structure 100 are important design parameters for user convenience, the redesigned vehicle interior molded rubber structure 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle interior structure forming a stable shape comprising:
a vehicle interior structure having a molded rubber frame for forming a support frame of a vehicle;
wherein said molded rubber frame having a screen cavity, a pair of screen pillars, a roof panel, a rear quarter panel, a front panel, a base member, and a pair of center pillars;
wherein said molded rubber frame is a one-piece structure;
wherein said screen cavity having a frame for installing a windshield;
wherein said roof panel is formed between said pair of screen pillars and said rear quarter panel;
wherein said front panel having a front cavity for accommodating an engine and other electronic vehicle components;
wherein said front panel having a scuttle member for supporting said front panel;
wherein said base member supports a base of the vehicle; and
further wherein said pair of center pillars providing support to doors and sides of the vehicle in conjunction with said molded rubber frame.

2. The vehicle interior structure forming a stable shape of claim 1, wherein said molded rubber frame formed from injection molding.

3. The vehicle interior structure forming a stable shape of claim 1, wherein said molded rubber frame formed from liquid silicone rubber (LSR) molding.

4. The vehicle interior structure forming a stable shape of claim 2, wherein said molded rubber frame having a material selected from a group consisting of a synthetic rubber, an EPDM Rubber, a Nitrile Rubber, and a Silicone Rubber.

5. The vehicle interior structure forming a stable shape of claim 3, wherein said molded rubber frame having a material selected from a group consisting of a synthetic rubber, an EPDM Rubber, a Nitrile Rubber, and a Silicone Rubber.

6. The vehicle interior structure forming a stable shape of claim 1, wherein said molded rubber frame having automotive metal body components fastened thereto for forming the vehicle.

7. The vehicle interior structure forming a stable shape of claim 6, wherein said automotive metal body components having a plurality of doors, a roof, and a front portion.

8. The vehicle interior structure forming a stable shape of claim 7, wherein said fastened metal body components having mechanical fasteners.

9. The vehicle interior structure forming a stable shape of claim 7, wherein said fastened metal body components having adhesive fasteners.

10. The vehicle interior structure forming a stable shape of claim 8, wherein said vehicle is selected from a group consisting of a car, a truck, an SUV, and an aircraft.

11. A vehicle interior structure forming a stable shape comprising:
a vehicle interior structure having a molded rubber frame for forming a support frame of a vehicle;
wherein said molded rubber frame having a screen cavity, a pair of screen pillars, a roof panel, a rear quarter panel, a front panel, a base member, and a pair of center pillars;
wherein said screen cavity having a frame for installing a windshield;
wherein said roof panel is formed between said pair of screen pillars and said rear quarter panel;
wherein said front panel having a front cavity for accommodating an engine and other electronic vehicle components;
wherein said front panel having a scuttle member for supporting said front panel;
wherein said base member supports a base of the vehicle;
wherein said pair of center pillars providing support to doors and sides of the vehicle in conjunction with said molded rubber frame; and
further wherein said molded rubber frame having a material selected from a group consisting of a synthetic rubber, an EPDM Rubber, a Nitrile Rubber, and a Silicone Rubber.

12. The vehicle interior structure forming a stable shape of claim 11, wherein said molded rubber frame formed from injection molding.

13. The vehicle interior structure forming a stable shape of claim 11, wherein said molded rubber frame formed from liquid silicone rubber (LSR) molding.

14. The vehicle interior structure forming a stable shape of claim 12, wherein said molded rubber frame is a one-piece structure.

15. The vehicle interior structure forming a stable shape of claim 13, wherein said molded rubber frame is a one-piece structure.

16. The vehicle interior structure forming a stable shape of claim 14, wherein said molded rubber frame having automotive metal body components fastened thereto for forming the vehicle.

17. The vehicle interior structure forming a stable shape of claim 16, wherein said automotive metal body components having a plurality of doors, a roof, and a front portion.

18. The vehicle interior structure forming a stable shape of claim 17, wherein said fastened metal body components having mechanical fasteners.

19. The vehicle interior structure forming a stable shape of claim 17, wherein said fastened metal body components having adhesive fasteners.

20. A vehicle interior structure forming a stable shape comprising:
a vehicle interior structure having a molded rubber frame for forming a support frame of a vehicle;
wherein said molded rubber frame having a screen cavity, a pair of screen pillars, a roof panel, a rear quarter panel, a front panel, a base member, and a pair of center pillars;
wherein said screen cavity having a frame for installing a windshield;
wherein said roof panel is formed between said pair of screen pillars and said rear quarter panel;
wherein said front panel having a front cavity for accommodating an engine and other electronic vehicle components;
wherein said front panel having a scuttle member for supporting said front panel;
wherein said base member supports a base of the vehicle;
wherein said pair of center pillars providing support to doors and sides of the vehicle in conjunction with said molded rubber frame;
wherein said molded rubber frame having a material selected from a group consisting of a synthetic rubber, an EPDM Rubber, a Nitrile Rubber, and a Silicone Rubber;
wherein said molded rubber frame is a one-piece structure;
wherein said molded rubber frame having automotive metal body components fastened thereto for forming the vehicle;
wherein said automotive metal body components having a plurality of doors, a roof, and a front portion;
wherein said fastened metal body components having mechanical fasteners; and
further wherein said vehicle is selected from a group consisting of a car, a truck, an SUV, and an aircraft.
